(19) United States
(12) Patent Application Publication
(10) Pub. No.: US 2013/0294634 A1
(43) Pub. Date: Nov. 7, 2013

(54) EARPHONE SET WITH INTERCHANGEABLE IN-EAR AND IN-CONCHA CAPS

(71) Applicant: HON HAI PRECISION INDUSTRY CO., LTD., New Taipei (TW)

(72) Inventor: HWANG-MIAW CHEN, New Taipei (TW)

(73) Assignee: HON HAI PRECISION INDUSTRY CO., LTD., New Taipei (TW)

(21) Appl. No.: 13/710,283

(22) Filed: Dec. 10, 2012

(30) Foreign Application Priority Data
May 3, 2012 (CN) 201210133584.0

(51) Int. Cl. H04R 1/10

(52) U.S. Cl. CPC H04R 1/1016
USPC 381/380

(57) ABSTRACT

An exemplary earphone set includes a shell, a speaker received in the shell, and an in-ear cap and an in-concha cap. The shell includes a sound tube having a first locking structure formed on an outer circumferential wall thereof. Each of the in-ear cap and the in-concha cap includes an inner tube having a second locking structure formed on an inner circumferential wall thereof, and a casing extending from a front end of the inner tube towards the shell. The first locking structure is detachably lockable with the second locking structure of one of the in-ear cap and the in-concha cap as selected by a user.

### BACKGROUND

1. Technical Field

The disclosure generally relates to audio devices, and particularly to an earphone set having an in-ear cap and an in-concha cap which are interchangeable.

2. Description of Related Art

With the continuing development of numerous technologies, earphones have been widely used in different fields, such as telephone communication, audio players, music reproduction, and so on.

There are two types of popular earphones, namely the in-concha earphone and the in-ear earphone. The in-concha earphone is generally received within the concha of the ear of a user (generally the area of the ear surrounding the opening of the ear canal). The in-ear earphone is generally partially received within the ear canal of a user. The two types of earphones are retained within the ear by interference engagement in the concha or interference engagement in the ear canal. Accordingly, the in-concha and in-ear earphones can be worn with relatively low profile.

Some users may want to change from one type of earphone to the other type of earphone according to different environments or requirements. For example, the in-concha earphone is generally considered more comfortable to wear than the in-ear earphone, whereas the in-ear earphone is generally considered to have better sound quality than the in-concha earphone. The need to change from one type of earphone to the other may involve extra cost and be inconvenient.

What is needed, therefore, is a means which can overcome the described limitations.

### BRIEF DESCRIPTION OF THE DRAWINGS

Many aspects of the present earphone set can be better understood with reference to the following drawings. The components in the drawings are not necessarily drawn to scale, the emphasis instead being placed upon clearly illustrating the principles of the present earphone set. Moreover, in the drawings, like reference numerals designate corresponding parts throughout the several views.

FIG. 1 is an assembled, isometric view of one use of an earphone set in accordance with an embodiment of the present disclosure, wherein an in-ear cap is incorporated in the earphone.

FIG. 2 is an exploded, isometric view of the earphone of FIG. 1.

FIG. 3 is an isometric view of a front cover of the earphone of FIG. 2.

FIG. 4 is an isometric view of a rear cover of the earphone of FIG. 2.

FIG. 5 is a cross sectional view of the earphone of FIG. 1, taken along line V-V thereof.

FIG. 6 is an enlarged, exploded view corresponding to a circled portion VI-VI of FIG. 5, showing a joint portion between the front and rear covers of the earphone.

FIG. 7 is an enlarged, exploded view corresponding to a circled portion VII-VII of FIG. 5, showing another joint portion between the front and rear covers of the earphone.

FIG. 8 is similar to FIG. 5, but showing an in-concha cap having replaced the in-ear cap of FIG. 5.

FIG. 9 is similar to FIG. 8, showing an earphone in accordance with another embodiment of the present disclosure.

### DETAILED DESCRIPTION

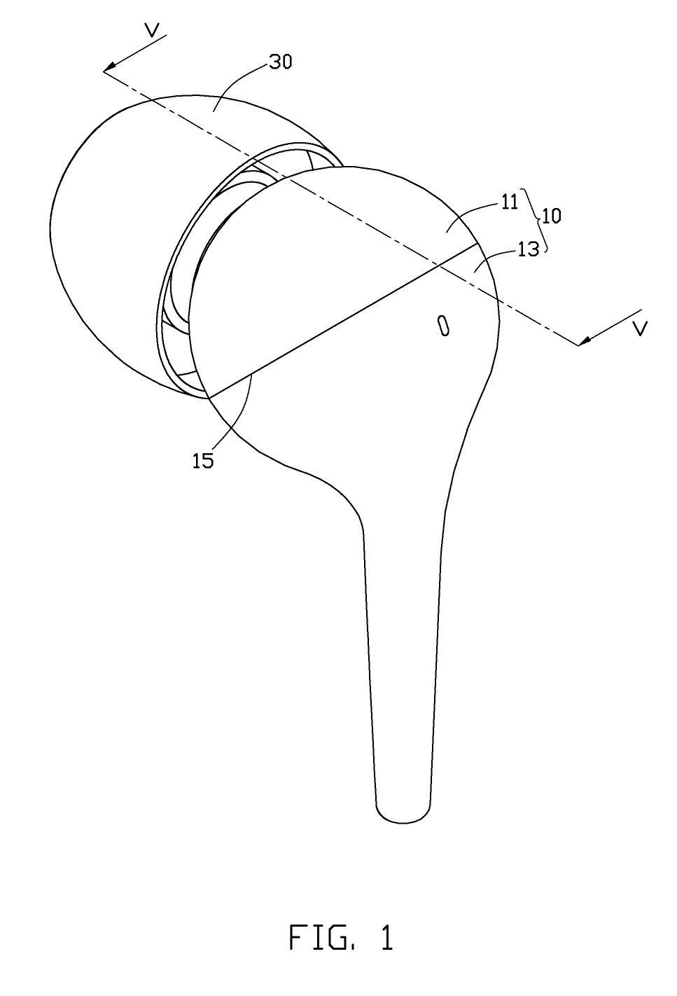

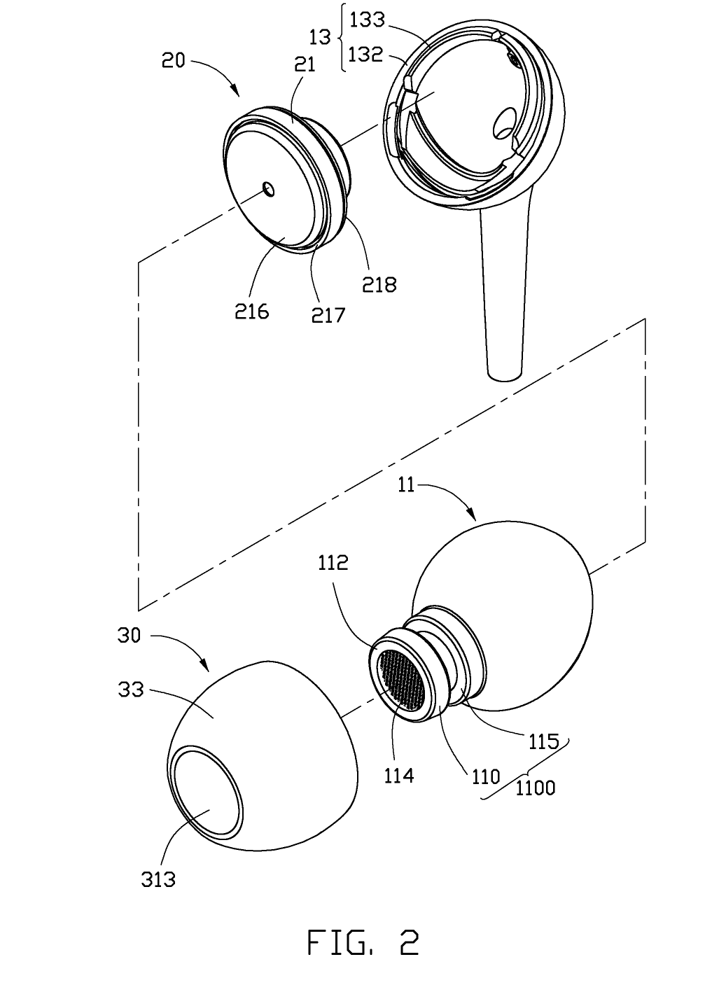

Referring to FIGS. 1 and 2, an earphone according to an embodiment of the disclosure is shown. The earphone includes a shell 10, a speaker 20 received in the shell 10, and a rubber in-ear cap 30 at a front end of the shell 10. The shell 10 includes a front cover 11, a sound tube 112 extending from the front cover 11, and a rear cover 13 joined with the front cover 11. A joint plane 15 is defined through a joint portion between the front and rear covers 11, 13.

Referring to FIGS. 2, 3, 5 and 7, the front cover 11 is hollow and substantially hemispheric, and defines a front chamber 111 therein. The sound tube 112 extends horizontally and outwardly from a front end of the front cover 11 toward the in-ear cap 30. A longitudinal axis of the sound tube 112 is non-perpendicular to the joint plane 15 between the front and rear covers 11, 13. The sound tube 112 is hollow and substantially cylindrical, and defines a sound channel 113 therein in communication with the front chamber 111. A tuning mesh 114 is disposed at a front end of the sound channel 113, for improving the sound quality factor and adjusting the sound sharpness of the speaker 20.

A rear end portion of the sound channel 113 expands gradually from an extremity thereof nearer the in-ear cap 30 toward the front cover 11 to form a frustoconical (or flared) shape at the rear end of the sound channel 113, such that sound from the speaker 20 readily enters the sound channel 113. The sound tube 112 defines an annular joint groove 115 in an outer circumferential wall thereof. The sound tube 112 has an outer diameter gradually decreasing from the joint groove 115 toward a front end of the sound tube 112. In addition, due to the provision of the joint groove 115, an annular protrusion 110 is defined at the front end of the sound tube 112. The annular protrusion 110 has an inclined outer surface 116, in order to assist in mounting the in-ear cap 30 around the sound tube 112. The annular protrusion 110 and the joint groove 115 cooperatively form a locking structure 1100 for engaging with the in-ear cap 30.

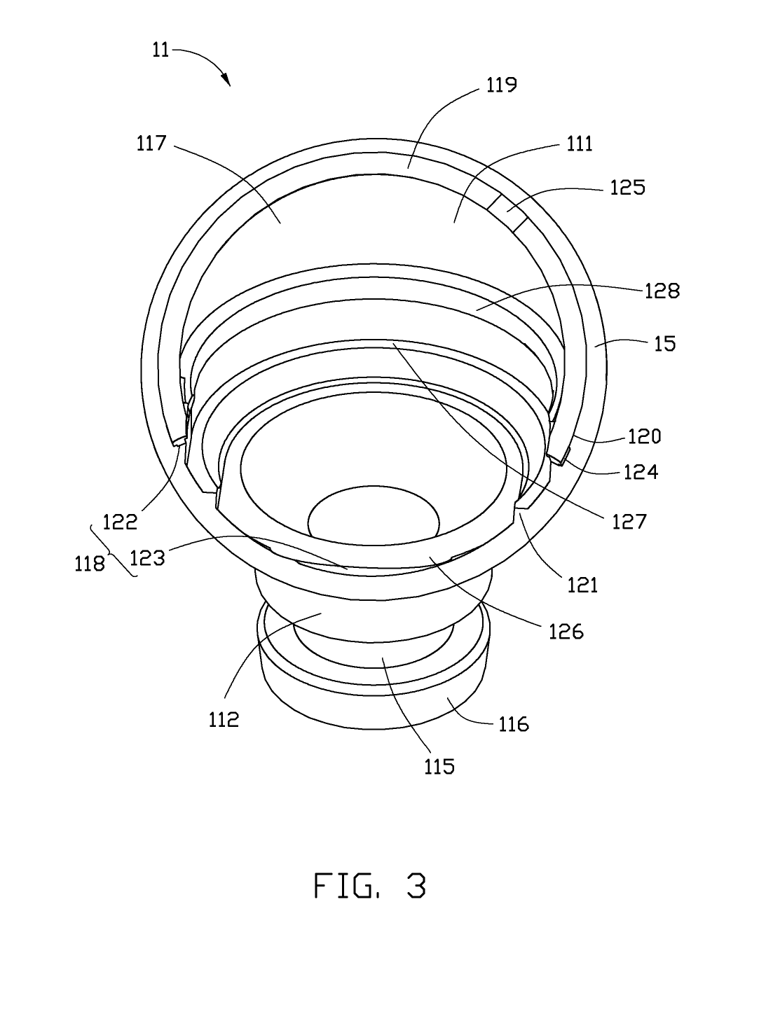

The front cover 11 defines an opening 117 at a rear end thereof. The front cover 11 has a fixing flange 118 extending out from a rear side thereof adjacent to the opening 117. The fixing flange 118 expands outwardly to form a protrusion 119 at a free end thereof, whereby a mounting groove 120 is defined in an outer surface of the fixing flange 118 adjacent to and above the protrusion 119. In the present embodiment, the protrusion 119 is in the form of a bead and has a circular cross-section. The fixing flange 118 defines two fixing cutouts 121 (shown in FIG. 3) at left and right sides of a bottom portion thereof, respectively. The two fixing cutouts 121 divide the fixing flange 118 into two parts, i.e., an upper portion 122 above the two fixing cutouts 121 and a lower portion 123 below the two fixing cutouts 121. The upper and lower portions 122, 123 of the fixing flange 118 are located in a same circle (not shown). Two blocks 124 (only one shown in FIG. 3) extend respectively outwardly from two opposite sides of the upper portion 122 of the fixing flange 118 into the mounting groove 120. The mounting groove 120 is closed off along a circumferential direction of the front cover 11 by the blocks 124. The upper portion 122 of the fixing flange 118 defines a positioning cutout 125 adjacent to a middle thereof.

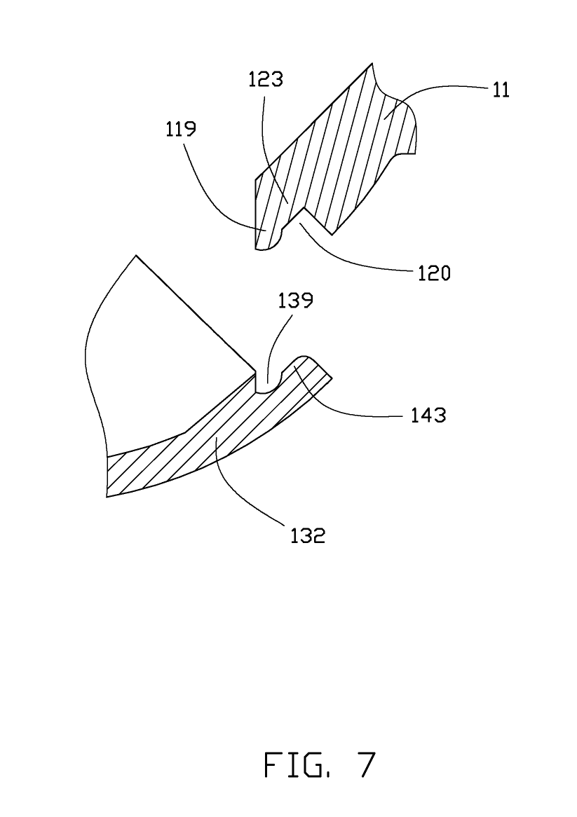

The front cover 11 forms a first step 126 and a second step 127 at an inner surface thereof, with both the first and second steps 126, 127 facing toward the front chamber 111. The first and second steps 126, 127 are planar, and parallel to each other. The longitudinal axis of the sound tube 112 is perpendicular to the first step 126. In other words, the first step 126 is nonparallel to the joint plane 15 between the front and rear covers 11, 13. The first step 126 is located below the second step 127 (as viewed in FIG. 3). The first step 126 is located adjacent to the sound tube 112, and cuts the lower portion 123 of the fixing flange 118 such that a cross-section of the lower portion 123 is approximately triangular (see FIG. 7). The protrusion 119 of the lower portion 123 of the fixing flange 118 is also cut by the first step 126 such that the protrusion 119 has an approximately hemispheric (or sub-hemispheric) cross-section (see FIG. 7). The front cover 11 further has a semicircular positioning flange 128 protruding inwardly from the inner surface thereof toward the front chamber 111. The positioning flange 128 is located above the second step 127 (as viewed in FIG. 3). A central plane 129 of the positioning flange 128 along a circumferential direction thereof is parallel to the first step 126. In other words, the central plane 129 is nonparallel to the joint plane 15 between the front and rear covers 11, 13.

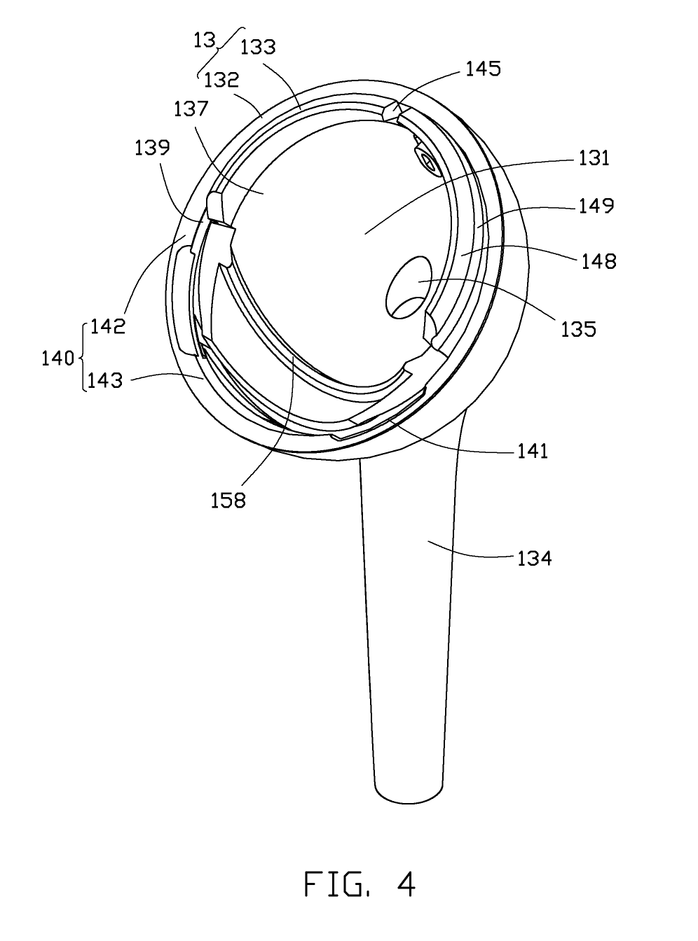

Referring to FIGS. 4-7, the rear cover 13 is also hollow and substantially hemispheric, and defines a rear chamber 131 therein. The rear cover 13 defines an opening 137 at a front end thereof. The opening 137 faces the opening 117 of the front cover 11. The rear cover 13 includes an outer cover 132 and an inner cover 133 in the outer cover 132. The inner cover 133 is made of a rigid material, such as polyvinyl chloride (PVC) and so on, and is for supporting the speaker 20. The outer cover 132 is made of a material which has a rigidity less than that of the inner cover 133 and a toughness greater than that of the inner cover 133, such as rubber and so on, and is for improving a texture of an outer surface of the earphone and preventing rupture of the earphone.

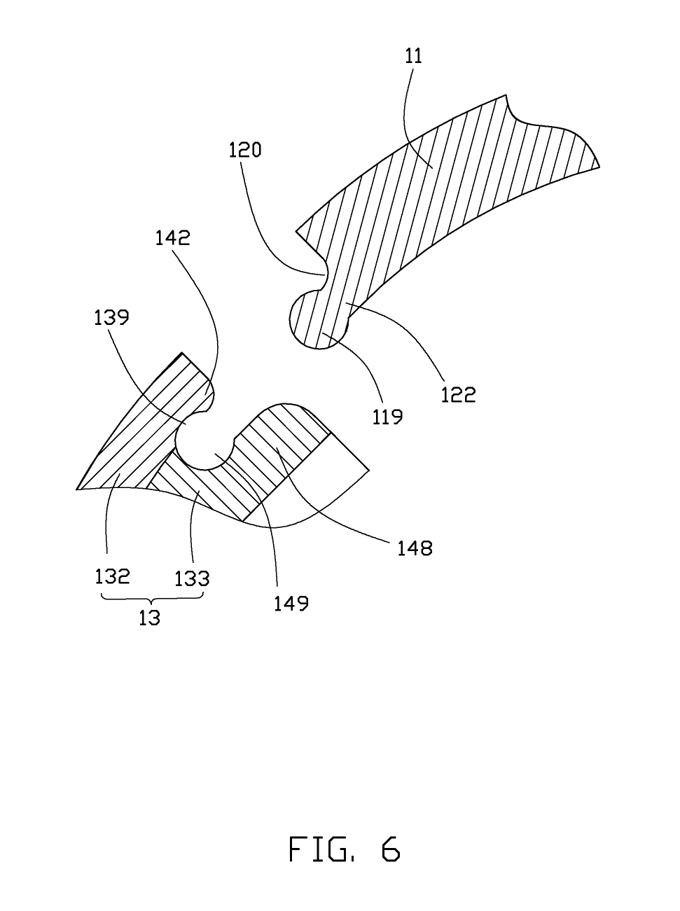

The outer cover 132 defines an annular fixing groove 139 in an inner surface thereof. The fixing groove 139 defines an arc-shaped cross-section (see FIG. 6). The fixing groove 139 is located at a front end of the outer cover 132 adjacent to the opening 137. A mounting flange 140 corresponding to the fixing groove 139 is formed at the front end of the outer cover 132. The mounting flange 140 defines two fixing cutouts 141 at left and right sides of a bottom thereof, respectively. The fixing cutouts 141 align with the fixing cutouts 121 of the front cover 11, respectively, such that the speaker 20 is not blocked by the mounting flange 140 of the rear cover 13 and the fixing flange 118 of the front cover 11 during assembly. The two fixing cutouts 141 also divide the mounting flange 140 into two parts, i.e., an upper portion 142 above the two fixing cutouts 141 and a lower portion 143 below the two fixing cutouts 141. The outer cover 132 has a hollow cable duct 134 extending downwardly at a rear end thereof. The cable duct 134 is provided for a cable (not shown) of the earphone to pass therethrough and electrically connect with the speaker 20.

The inner cover 133 is adhered to the inner surface of the outer cover 132. The rear chamber 131 is defined in the inner cover 133. The inner cover 133 has a securing flange 148 extending forwardly from an inner side thereof adjacent to the opening 137. The securing flange 148 is semi-annular, and is located at a top of the inner cover 133. The securing flange 148 defines a fixing groove 149 in an outer surface thereof. The fixing groove 149 defines a semicircular cross-section. The fixing grooves 139, 149 of the outer and inner covers 132, 133 cooperatively form a groove (not labeled) with an arc-shaped (almost circular) cross-section, for matching the protrusion 119 of the front cover 11 (see FIG. 6). The securing flange 148 defines a positioning cutout 145 in a middle thereof. The positioning cutout 145 aligns with the positioning cutout 125 of the front cover 11, whereby the front and rear covers 11, 13 can be positioned accurately during assembly.

The inner cover 133 has a semicircular positioning flange 158 protruding outwardly at an inner surface thereof toward the rear chamber 131. The semicircular positioning flanges 128, 158 of the front and inner covers 11, 133 cooperatively form a circular flange. The inner cover 133 defines a through hole 135 in a rear end thereof, in communication with the cable duct 134 of the outer cover 132.

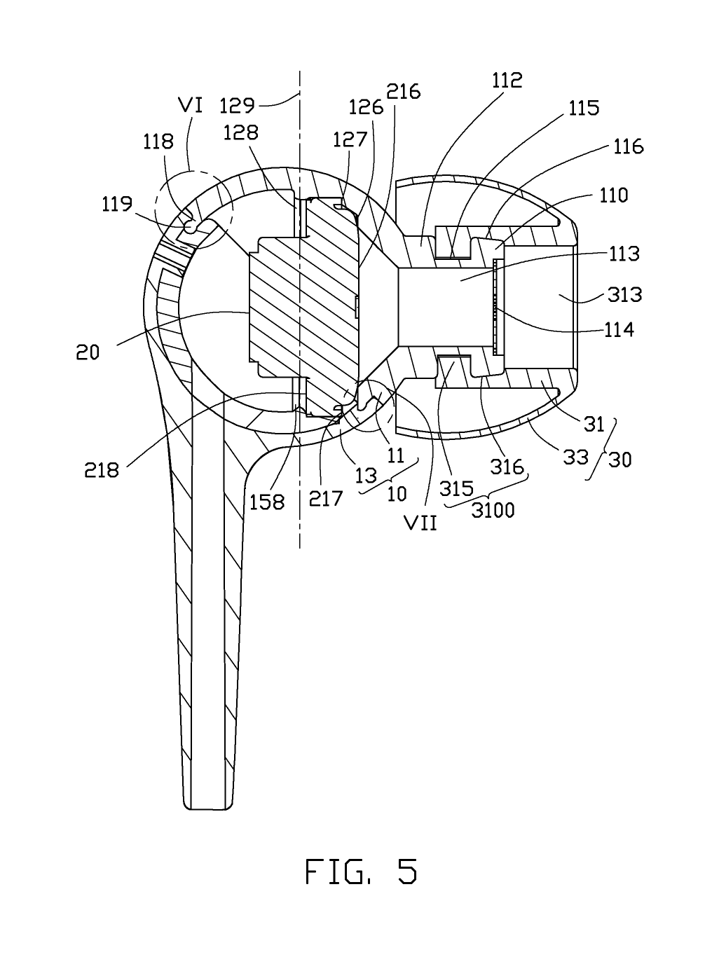

Referring to FIGS. 2 and 5, the in-ear cap 30 is typically made of soft rubber material. The in-ear cap 30 includes an inner tube 31, and an outer casing 33 bending rearward from a front end of the inner tube 31, with the inner tube 31 located in the casing 33. The inner tube 31 is hollow and cylindrical, and defines a sound passage 313 therein. The sound passage 313 communicates with the sound channel 113 of the front cover 11. The inner tube 31 forms a locking structure 3100 engaging with the locking structure 1100 of the front cover 11 for fixing the shell 10 with the in-ear cap 30. The locking structure 3100 has an annular joint flange 315 protruding inwardly from a rear end of the inner tube 31 into the sound passage 313. The joint flange 315 is engaged in the joint groove 115 of the sound tube 112 of the front cover 11. A height of the joint flange 315 is slightly less than a depth of the joint groove 115 as measured along a radial direction of the sound passage 313 and a radial direction of the sound channel 113, respectively. The locking structure 3100 further includes an inclined groove 316 in front of the joint flange 315. A depth of the inclined groove 316 along the radial direction of the sound passage 313 gradually decreases in a forward direction, thereby complementarily matching the inclined outer surface 116 of the sound tube 112.

The inner tube 31 is attached to the sound tube 112 by pushing the in-ear cap 30 towards the shell 10 from a position in front of the shell 10, until the joint flange 315 is fitted into the joint groove 115 and the annular protrusion 110 is simultaneously fitted into the inclined groove 316. The inner tube 31 is thus in interference engagement with the sound tube 112. The inner tube 31 can also be detached from the sound tube 112 by forcing the joint flange 315 away from the joint groove 115 and simultaneously forcing the annular protrusion 110 away from the inclined groove 316. The casing 33 has an outer diameter first increasing from a front end thereof along a rearward direction towards the shell 10 and then decreasing slightly from a middle portion thereof along the rearward direction to a rear end thereof. The rear end of the casing 33 is spaced from the shell 10 and the inner tube 31, and terminates at a position corresponding to the front end of the front cover 11.

The speaker 20 includes a frame 21. The frame 21 has a first abutting portion 216 and a second abutting portion 217 at a front end thereof, and a positioning portion 218 at a rear end thereof. The first abutting portion 216 is circular and has a substantially flat front face. The second abutting portion 217 is annular and has a planar front face. The positioning portion 218 is annular and has a planar rear face.

During assembly of the earphone, the speaker 20 is pushed into the front chamber 111 of the front cover 11 through the fixing cutouts 121 of the front cover 11. The first and second abutting portions 216, 217 of the speaker 20 abut against the first and second steps 126, 127 of the front cover 11, respectively. The positioning portion 218 of the speaker 20 abuts against the positioning flange 128 of the front cover 11. Then the fixing grooves 139, 149 of the rear cover 13 are aligned with the fixing flange 118 of the front cover 11. The rear cover 13 is pressed toward the front cover 11 until the protrusion 119 of the fixing flange 118 of the front cover 11 is snappingly engaged in the fixing grooves 139, 149 of the rear cover 13, with the upper and lower portions 142, 143 of the mounting flange 140 of the rear cover 13 simultaneously engaged in the mounting groove 120 of the fixing flange 118 of the front cover 11. At this time, two ends of the upper portion 142 of the mounting flange 140 of the rear cover 13 adjacent to the fixing cutouts 141 abut against the blocks 124 of the upper portion 122 of the fixing flange 118 of the front cover 11, respectively. The positioning flange 158 of the rear cover 13 and the positioning flange 128 of the front cover 11 cooperatively form an annular flange. The positioning portion 218 of the speaker 20 abuts against the positioning flange 158 of the rear cover 13 and the positioning flange 128 of the front cover 11.

In this position, the rear end of the sound passage 313 of the in-ear cap 30 adjacent to the joint flange 315 is aligned with the sound tube 112 of the front cover 11. Then the in-ear cap 30 is pressed toward the front cover 11 to attach the in-ear cap 30 to the sound tube 112.

In the earphone, the protrusion 119 of the front cover 11 is engaged in the fixing grooves 139, 149 of the rear cover 13. Thereby, the front and rear covers 11, 13 can be joined together steadily, and the front and rear covers 11, 13 can be attached together and detached from each other conveniently. There is no need to provide adhesive to join the front and rear covers 11, 13 together, thereby obviating any risk of an insecure joint between the front and rear covers 11, 13 due to decay of the adhesive. In addition, the mounting flange 140 of the rear cover 13 is engaged in the mounting groove 120 of the front cover 11, which further securely joins the front and rear covers 11, 13 together. Furthermore, the two ends of the upper portion 142 of the mounting flange 140 of the rear cover 13 adjacent to the fixing cutouts 141 abut against the blocks 124 of the upper portion 122 of the front cover 11, respectively. Accordingly, the rear cover 13 is prevented from rotating along a circumferential direction of the shell 10 after assembly, so that the rear cover 13 is firmly attached to the front cover 11.

Moreover, the first and second abutting portions 216, 217 of the speaker 20 abut respectively against the first and second steps 126, 127 of the front cover 11, and the positioning portion 218 of the speaker 20 abuts against the positioning flanges 128, 158 of the front and rear covers 11, 13. In other words, the speaker 20 is sandwiched between the steps 126, 127 and the positioning flanges 128, 158, which helps to secure the speaker 20 in the earphone. The positioning flanges 128, 158 are respectively formed on the front and rear covers 11, 13, and the central plane 129 of the positioning flange 128 is nonparallel to the joint plane 15 between the front and rear covers 11, 13. Accordingly, the speaker 20 can be slid into the front cover 11 from an outer side of the front cover 11. That is, it is convenient to assemble the speaker 20 into the shell 10.

Alternatively, the protrusion 119 and the mounting groove 120 of the front cover 11 can be formed on the rear cover 13 instead, and correspondingly, the fixing grooves 139, 149 and the mounting flange 140 of the rear cover 13 can be formed on the front cover 11 instead.

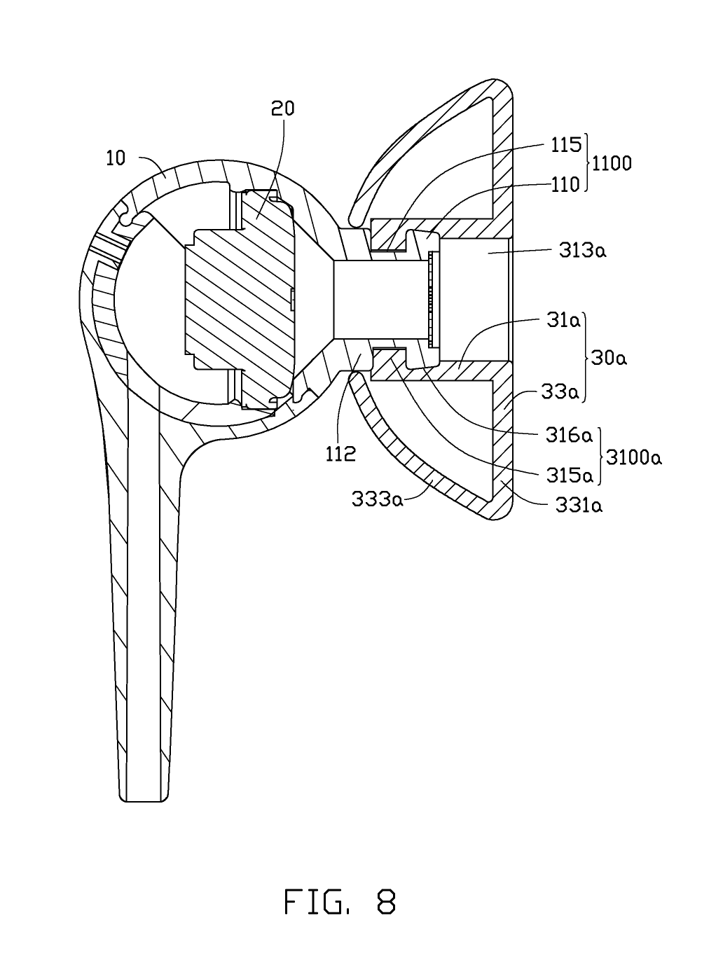

FIG. 8 shows the earphone using an in-concha cap 30a instead of the in-ear cap 30. The in-concha cap 30a includes an inner tube 31a, and a casing 33a formed outwardly and rearward from a front end of the inner tube 31a. The inner tube 31a has a configuration the same as that of the inner tube 31 of the in-ear cap 30. The inner tube 31a includes a locking structure 3100a at a rear end thereof for engaging with the locking structure 1100 of the shell 10. The locking structure 3100a includes a joint flange 315a and an inclined groove 316a adjacent to the joint flange 315a. The joint flange 315a is retained in the joint groove 115 of the shell 10, and the inclined groove 316a receives the annular protrusion 110 of the shell 10 therein. The casing 33a includes an annular plate 331a, and a wall 333a curved rearward from a periphery of the annular plate 331a towards the shell 10. The annular plate 331 a is perpendicular to a central axis of the inner tube 31a. The wall 333a has an outer diameter gradually decreasing from a front end thereof towards the shell 10. A rear end of the wall 333a abuts against an outer circumferential face of the sound tube 112, so that the wall 333a is supported by the sound tube 112. The rear end of the wall 333a has a semicircular cross-section. The rear end of the wall 333a is slidable along the outer circumferential face of the sound tube 112 when the in-concha cap 30a is deformed. The in-concha cap 30a can be detached from the sound tube 112 like the in-ear cap 30. Thus, a user of the earphone can conveniently select and fit either one of the in-ear cap 30 and the in-concha cap 30a according to actual requirements.

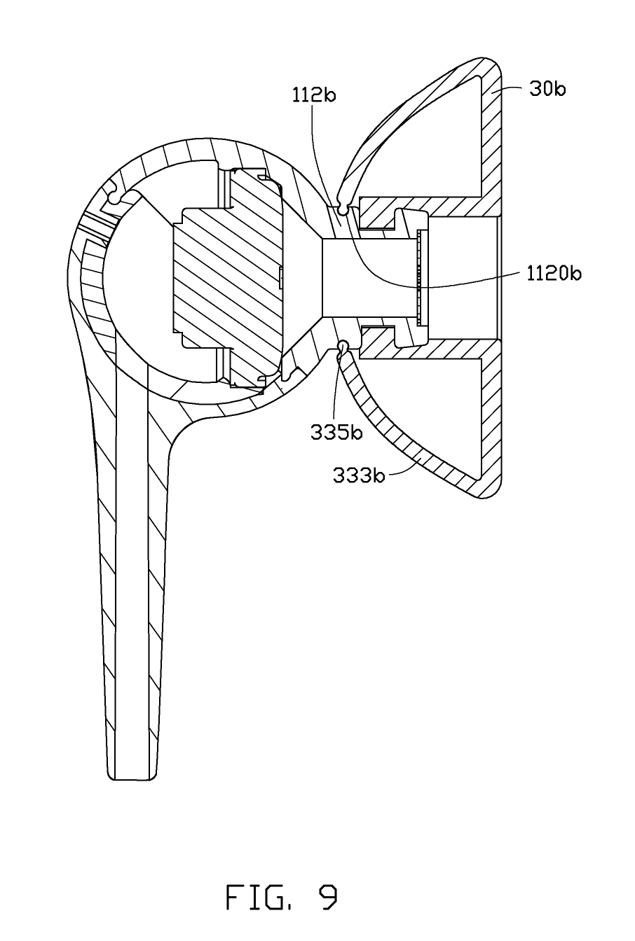

Furthermore, in an alternative embodiment, the rear end of the wall 333b can be fixed to the sound tube 112 for increasing the strength of the in-concha cap 30b. Referring to FIG. 9, the rear end of the wall 333b of the in-concha cap 30b forms an annular bead 335b inserted and snap-fitted into a corresponding annular groove 1120b defined in the sound tube 112b. The annular bead 335b has a circular cross-section similar to that of the protrusion 119 of the front cover 11. Thus, the annular bead 335b of the wall 333b is fittingly and reliably engaged in the sound tube 112b.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An earphone set comprising:
a shell comprising a sound tube defining a sound channel, the sound tube forming a first locking structure on an outer circumferential wall thereof;
a speaker received in the shell to produce sound propagating through the sound channel; and
an in-ear cap and an in-concha cap each comprising:
an inner tube forming a second locking structure on an inner circumferential wall thereof; and
a casing extending from a front end of the inner tube towards the shell;
wherein the first locking structure of the sound tube is detachably lockable with the second locking structure of each one of the in-ear cap and the in-concha cap as selected by a user.

2. The earphone set of claim 1, wherein the first locking structure comprises a joint groove, and the second locking structure comprising a joint flange fittingly received in the joint groove.

3. The earphone set of claim 2, wherein the joint groove is annular and surrounds the sound channel.

4. The earphone set of claim 2, wherein the joint groove is located at a middle of the sound tube along an elongated direction of the sound tube.

5. The earphone set of claim 2, wherein the joint flange is annular and located at an end of the inner tube.

6. The earphone set of claim 2, wherein the first locking structure further comprises an annular protrusion, and the second locking structure further comprises an annular groove fittingly receiving the annular protrusion.

7. The earphone set of claim 6, wherein the annular protrusion is located at an end of the sound tube, adjacent to the joint groove.

8. The earphone set of claim 6, wherein the annular protrusion has an inclined outer circumferential face, and the annular groove has an inclined inner circumferential face matching the inclined outer circumferential face of the annular protrusion.

9. The earphone set of claim 8, wherein the annular protrusion has an outer diameter gradually decreasing along an elongated direction of the sound tube away from the joint groove.

10. The earphone set of claim 1, wherein an outer diameter of the casing of the in-ear cap firstly increases and then reduces along an elongated direction of the sound tube towards the shell.

11. The earphone set of claim 10, wherein the casing of the in-ear cap has a first end away from the shell and connected to the inner tube of the in-ear cap, and a second end adjacent to and spaced from the shell.

12. The earphone set of claim 11, wherein the second end of the casing of the in-ear cap is not in contact with the shell.

13. The earphone set of claim 1, wherein an outer diameter of the casing of the in-concha cap gradually reduces along an elongated direction of the sound tube towards the shell.

14. The earphone set of claim 13, wherein the casing of the in-concha cap comprises an annular plate extending radially outwardly from the inner tube and a wall extending curvedly from a periphery of the annular plate towards the shell.

15. The earphone set of claim 14, wherein the plate of the in-concha cap is substantially perpendicular to a central axis of the inner tube.

16. The earphone set of claim 14, wherein the wall of the in-concha cap has a first end connected to the annular plate and a second end extending towards the sound tube.

17. The earphone set of claim 16, wherein the second end of the wall of the in-concha cap abuts against and contacts a face of the outer circumferential wall of the sound tube.

18. The earphone set of claim 17, wherein the second end of the wall of the in-concha cap is slidable along the face of the outer circumferential wall of the sound tube when the in-concha cap is fitted onto the sound tube.

19. The earphone set of claim 17, wherein the second end of the wall of the in-concha cap is engaged in an annular groove defined in the outer circumferential wall of the sound tube when the in-concha cap is fitted onto the sound tube.

20. An earphone comprising:
a shell comprising a sound tube defining a sound channel, the sound tube forming a first locking structure on an outer circumferential wall thereof;
a speaker received in the shell;
a cap, which is one of an in-ear cap and an in-concha cap, the cap comprising:
an inner tube forming a second locking structure on an inner circumferential wall thereof; and
a casing extending from a front end of the inner tube rearward towards the shell;
wherein the second locking structure is detachably lockable with the first locking structure such that the cap is detachably fitted onto the shell, and the second locking structure is removable from the first locking structure such that the cap is replaceable by the other one of the in-ear cap and the in-concha cap.
